(19) United States
(12) Patent Application Publication
(10) Pub. No.: US 2014/0184168 A1
(43) Pub. Date: Jul. 3, 2014

(54) APPARATUS AND METHOD FOR EQUALIZING ENERGY OF BATTERY CELLS

(71) Applicant: Sang Chil Park, Yongin-si (KR)

(72) Inventor: Sang Chil Park, Yongin-si (KR)

(73) Assignee: HYUNDAI MOBIS CO.,LTD., Yongin-si (KR)

(21) Appl. No.: 14/043,368

(22) Filed: Oct. 1, 2013

(30) Foreign Application Priority Data
Dec. 27, 2012 (KR) 10-2012-0154406

(51) Int. Cl. H02J 7/00

(52) U.S. Cl. CPC H02J 7/0014
USPC 320/136

(57) ABSTRACT

Provided are an apparatus and method for equalizing energy of battery cells. The apparatus includes a cell balancing controller, a cell balancing executor, and a temperature detector. The cell balancing controller detects a voltage of each of a plurality of cells included in a battery pack and, when a cell requiring cell balancing is extracted, decides a balancing duty to execute discharging control. The cell balancing executor discharges a voltage charged in each cell according to a cell balancing duty signal applied from the cell balancing controller. The temperature detector continuously monitors a temperature of the cell balancing executor to supply the monitored result to the cell balancing controller, and decides the balancing duty on the basis of a cell voltage differential and the temperature of the cell balancing executor.

### CROSS-REFERENCE TO RELATED APPLICATIONS

This application claims priority under 35 U.S.C. §119 to Korean Patent Application No. 10-2012-0154406, filed on Dec. 27, 2012, the disclosure of which is incorporated herein by reference in its entirety.

### TECHNICAL FIELD

The present invention relates to an apparatus and method for equalizing energy of battery cells, and more particularly, to an apparatus and method for preventing a damage of a battery management system (BMS) and the firing of a battery due to an over-temperature when a battery module configured with a lithium-based secondary battery (lithium ion and lithium polymer) cell is performing a balancing operation for equalizing a cell voltage.

### BACKGROUND

Generally, batteries are variously used in electric and electronic fields, and a plurality of cells are serially connected for configuring a high-voltage battery.

In a plurality of cells configuring a high-voltage battery, as an operating time elapses, the charging voltages of the cells become different from each other by a difference between separate dynamic states of the cells due to a cooling efficiency and a capacity.

For this reason, at least one or more cells have a charging voltage far lower than the other cells, and thus, an entire discharging ability of a battery is permanently limited.

Moreover, at least one or more cells have a charging voltage far higher than the other cells, and thus, an entire charging amount of a battery is permanently limited.

For example, when one cell has a limit value of the lowest charging voltage and any other one cell has a limit value of the highest charging voltage, the battery cannot be charged or discharged although all of the other cells have an appropriate charging voltage.

To overcome this problem, a separate charging operation is performed on a cell having a low charging voltage through boosting, and a bucking operation for discharging charged energy is performed on a cell having a high charging voltage, thereby providing cell balancing for maintaining an overall balance.

The cell balancing may be stopped when balance of cells having a problem is made by a sufficiently satisfactory degree, and, when unbalance of the cells is considerable, the cell balancing may be again started.

A cell balancing method may use charging shift technology, which shifts a voltage from one or more cells having a high voltage to one or more cells having a low voltage to adjust a voltage balance, and a charging consumption technology that consumes voltages charged in one or more cells having a very high voltage by using a load.

The charging consumption technology controls a cell balancing switch to selectively perform a bucking operation on a cell requiring discharging, thereby reducing a voltage differential between cells.

However, when a switch for selecting a cell requiring discharging is defective or is damaged to always have a turn-on state, the bucking operation is always performed irrespective of control by a processor, and thus, the cell balancing can excessively increase a temperature of a battery management controller to cause the damage and firing of a component.

Moreover, even when the cell balancing is excessively performed by an error of the processor, the cell balancing can excessively increase the temperature of the battery management controller to cause the damage and firing of a component.

Furthermore, when a cell voltage is excessively lowered by the defect of the switch or the error of the processor, a main relay is turned off or a safety plug is separated through normal diagnosis, it is unable to remove a cause of the damage and firing of the component due to overheating.

Therefore, a cell balancing operation is limited at a ratio of 7:3 or 8:2 for preventing a risk of overheating, but, when it is impossible to control a duty due to a damage of a cell balancing switch or an error of switching control, the damage and firing of the battery management controller are inevitable.

Such problems are more excessively caused as the number of cells configuring a battery pack increases, causing a severe risk in driving hybrid electric vehicles (HEVs) and electric vehicles (EVs).

### SUMMARY

Accordingly, the present invention provides an apparatus and method for preventing a damage of an BMS and the firing of a battery due to an over-temperature when a battery module configured with a lithium-based secondary battery (lithium ion and lithium polymer) cell is performing a balancing operation for equalizing a cell voltage.

The present invention also provides an apparatus and method for varying a cell voltage equalization operation time depending on a temperature to maximize an equalization performance.

The object of the present invention is not limited to the aforesaid, but other objects not described herein will be clearly understood by those skilled in the art from descriptions below.

In one general aspect, an apparatus for equalizing energy of battery cells, including: a cell balancing controller configured to detect a voltage of each of a plurality of cells included in a battery pack and, when a cell requiring cell balancing is extracted, decide a balancing duty to execute discharging control; a cell balancing executor configured to discharge a voltage charged in each cell according to a cell balancing duty signal applied from the cell balancing controller; and a temperature detector configured to continuously monitor a temperature of the cell balancing executor to supply the monitored result to the cell balancing controller, the cell balancing controller deciding the balancing duty on the basis of a cell voltage differential and the temperature of the cell balancing executor.

When the cell voltage differential is greater than a first target differential, the cell balancing controller may compare the temperature of the cell balancing executor with a set temperature value, and, when the temperature of the cell balancing executor is not greater than the set temperature value as the compared result, the balancing duty may be decided as a maximum value. When the temperature of the cell balancing executor is greater than the set temperature value, the cell balancing controller may decide a balancing duty corresponding to the temperature of the cell balancing executor in a temperature-balancing function where the balancing duty is linearly reduced from a maximum value to zero within a range of from the set temperature value to a protection operation temperature value.

When the balancing duty is decided as the maximum value, the cell balancing controller may compare a second target differential with a cell voltage differential after a certain time elapses, and, when the cell voltage differential after the certain time is less than or equal to the second target differential as the compared result, the cell balancing controller may compulsorily terminate cell balancing by the cell balancing executor. When the cell voltage differential after the certain time is greater than the second target differential as the compared result, the cell balancing controller may compare the set temperature value with a temperature of the cell balancing executor after a certain time elapses.

In another general aspect, a method of equalizing energy of battery cells, including: (a) detecting a voltage of each of a plurality of cells included in a battery pack to compare a cell voltage differential with a first target differential; (b) when the cell voltage differential is greater than the first target differential, comparing a temperature of a cell balancing executor with a set temperature value; (c) when the temperature of the cell balancing executor is not greater than a set temperature value as the compared result, deciding a balancing duty as a maximum value; and (d) when the temperature of the cell balancing executor is greater than the set temperature value as the compared result, deciding a balancing duty corresponding to the temperature of the cell balancing executor in a temperature-balancing function where the balancing duty is linearly reduced from a maximum value to zero within a range of from the set temperature value to a protection operation temperature value.

The method may further include: when the balancing duty is decided as the maximum value in operation (c), comparing a second target differential with a cell voltage differential after a certain time elapses; when the cell voltage differential after the certain time is less than or equal to the second target differential as the compared result, compulsorily terminating cell balancing by the cell balancing executor; when the cell voltage differential after the certain time is greater than the second target differential as the compared result, comparing the set temperature value with a temperature of the cell balancing executor after a certain time elapses; and selectively performing operation (c) or operation (d) according to the compared result of the temperatures.

Other features and aspects will be apparent from the following detailed description, the drawings, and the claims.

### BRIEF DESCRIPTION OF THE DRAWINGS

FIG. 1 is a block diagram illustrating a schematic configuration of an apparatus for equalizing energy of battery cells according to an embodiment of the present invention.

FIG. 2 is a diagram illustrating an example in which the apparatus for equalizing energy of battery cells according to an embodiment of the present invention is actually mounted on a printed circuit board (PCB).

FIG. 3 is a flowchart illustrating a schematic procedure of a method of equalizing energy of battery cells according to an embodiment of the present invention.

### DETAILED DESCRIPTION OF EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. In the following description, the technical terms are used only for explaining a specific exemplary embodiment while not limiting the inventive concept. The terms of a singular form may include plural forms unless specifically mentioned.

Hereinafter, exemplary embodiments of the inventive concept will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

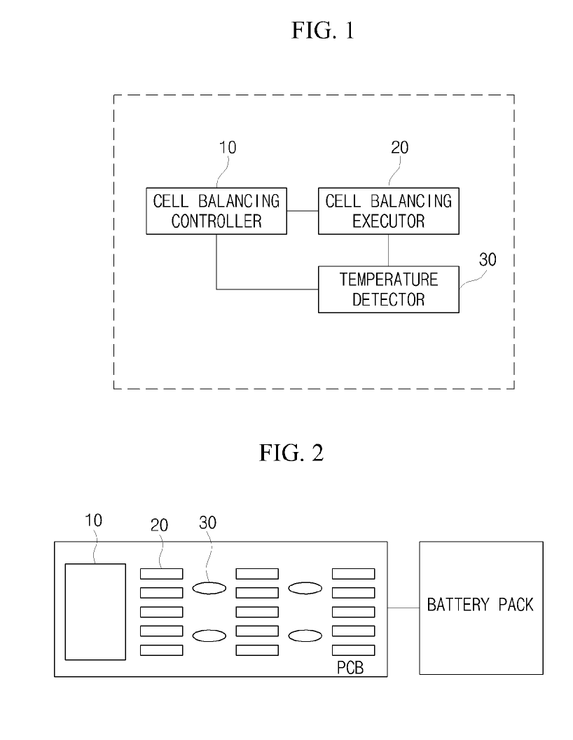

FIG. 1 is a block diagram illustrating a schematic configuration of an apparatus for equalizing energy of battery cells according to an embodiment of the present invention.

Referring to FIG. 1, the apparatus for equalizing energy of battery cells according to an embodiment of the present invention includes a cell balancing controller 10, a cell balancing executor 20, and a temperature detector 30.

The cell balancing controller 10 detects a voltage of each of a plurality of cells configuring a battery pack to detect a cell requiring cell balancing. When a cell having a voltage higher than or equal to an average voltage and requiring discharging is detected, the cell balancing controller 10 decides a balancing duty for discharging the cell, and execute discharging control at the decided duty to provide cell balancing in which a voltage differential between cells does not occur.

The battery pack includes a plurality of cells, for example, 88 cells, which charge a certain amount of voltage for outputting a high voltage and are serially connected.

The cell balancing executor 20, for example, may include a switch and a load resistor which are serially connected between both ends of each of the cells configuring the battery pack. The switch is turned off according to a cell balancing duty signal applied from the cell balancing controller 10, and discharges a voltage charged in each cell through the load resistor.

The temperature detector 30 continuously monitors a temperature of the cell balancing executor 20 to supply information on the monitored temperature to the cell balancing controller 10.

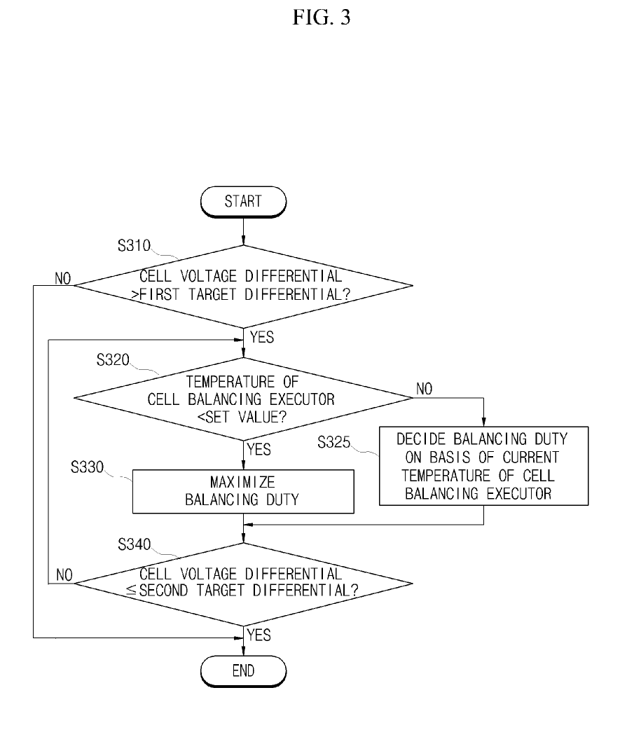

For example, as illustrated in FIG. 2, the cell balancing executor 20 and the temperature detector 30 are mounted as SMD components on one PCB, and thus, the resistor configuring the cell balancing executor 20 and a temperature sensor of the temperature detector 30 are closest disposed in position within a range that does not degrade an insulation performance between a resistor of a high voltage circuit and a temperature sensor of a low voltage circuit (denoting the cell balancing controller).

Therefore, a temperature measurement performance and accuracy of the cell balancing executor 20 can be greatly enhanced.

The apparatus for equalizing energy of battery cells according to an embodiment of the present invention decides a balancing duty for controlling cell balancing by using the detected voltage differential between cells and the detected temperature value of the cell balancing executor 20. Hereinafter, a balancing duty deciding method performed by the cell balancing controller 10 will be described in detail with reference to FIGS. 1 and 3.

FIG. 3 is a flowchart illustrating a schematic procedure of a method of equalizing energy of battery cells according to an embodiment of the present invention.

Referring to FIG. 3, first, the cell balancing controller 10 detects a voltage of each cell configuring the battery pack to calculate a cell voltage differential, and compares the cell voltage differential with a predetermined first target differential in operation S310.

Here, the first target differential is a reference value for determining whether the calculated cell voltage differential is a high value requiring a cell voltage equalization operation, and is previously set depending on a battery characteristic.

When the cell voltage differential is greater than the first target differential as the compared result, the cell balancing controller 10 compares a set temperature value with a temperature of the cell balancing executor 20 detected by the temperature detector 30 in operation S320.

When the temperature of the cell balancing executor 20 is greater than the set temperature value, the cell balancing controller 10 decides the balancing duty as the maximum value in operation S330.

Here, the set temperature value denotes a threshold value on whether a balancing duty for equalizing voltages of cells is set to the maximum value, and, when a current temperature of the cell balancing executor 20 is not greater than the threshold value, the cell balancing executor 20 performs cell balancing at maximum periods.

That is, when the cell voltage differential is greater than the first target differential and the currently detected temperature of the cell balancing executor 20 is not greater than the set temperature value, the cell balancing controller 10 sets the balancing duty to the maximum value (i.e., sets an equalization period for equalizing voltages of cells to the maximum value) to command the cell balancing executor 20 to perform an operation.

When the temperature of the cell balancing executor 20 is greater than the set temperature value as the compared result in operation S320, the cell balancing controller 10 decides a balancing duty on the basis of the current temperature of the cell balancing executor 20 in operation S325.

In an embodiment, when the temperature of the cell balancing executor 20 is greater than the set temperature value, the cell balancing controller 10 decides a balancing duty corresponding to the current temperature of the cell balancing executor 20 in a temperature-balancing function where the balancing duty is linearly reduced from the maximum value to zero within a range of from the set temperature value to a protection operation temperature value.

Here, the protection operation temperature value denotes a threshold value on whether to continuously perform the cell voltage equalization operation, and, when the current temperature of the cell balancing executor 20 is greater than the protection operation temperature value, the cell balancing controller 10 decides the balancing duty as zero.

The set temperature value and the protection operation temperature value are threshold values for controlling an operation of the cell balancing executor 20, and are differently set depending on a characteristic (for example, Watt. vs temperature correlation) of a resistor applied to the cell balancing executor 20.

For example, when the temperature of the cell balancing executor 20 is greater than or equal to the set temperature value, the balancing duty is set to the maximum value. When the temperature of the cell balancing executor 20 starts to exceed the set temperature value, the balancing duty is linearly reduced. When the temperature of the cell balancing executor 20 finally reaches the protection operation temperature value, the balancing duty is decided as zero.

When the balancing duty is decided as the maximum value in operation S330 as the compared result in operation S320, after a certain time elapses, the cell balancing controller 10 again detects voltages of cells to calculate a cell voltage differential, and compares the cell voltage differential with a second target differential that is a new reference value in operation S340.

When the cell voltage differential after the certain time is less than or equal to the second target differential as the compared result, the cell balancing by the cell balancing executor 20 is compulsorily terminated.

Here, the second target differential denotes the minimum threshold value on whether the cell voltage equalization operation is needed, and, when the calculated current cell voltage differential is less than or equal to the second target differential, the cell balancing controller 10 terminates the operation of the cell balancing executor 20 because the cell voltage equalization operation is not needed any longer.

When the cell voltage differential after the certain time is greater than the second target differential as the compared result in operation S340, operations S320 to S340 are recursively performed because the cell voltage equalization operation is still needed.

Specifically, the cell balancing controller 10 again compares the set temperature value with a temperature of the cell balancing executor 20 after a certain time elapses in operation S320, and operation S325 or S330 is selectively performed according to the compared result.

According to the present invention, as described above, since the balancing duty of the cell balancing executor varies depending on a temperature, a cell equalization time can be shortened in a low temperature range. Also, the protection operation against an abnormal operation can be performed, thus increasing a stability of products.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for equalizing energy of battery cells, the apparatus comprising:
a cell balancing controller configured to detect a voltage of each of a plurality of battery cells comprised in a battery pack and, decide a balancing duty to execute discharging control;
a cell balancing executor configured to discharge a voltage charged in each battery cell according to a cell balancing duty signal applied from the cell balancing controller; and
a temperature detector configured to monitor a temperature of the cell balancing executor to supply the monitored result to the cell balancing controller.

2. The apparatus of claim 1, wherein the cell balancing controller configured to decide the balancing duty on the basis of a cell voltage differential and the temperature of the cell balancing executor.

3. The apparatus of claim 1, wherein the cell balancing executor comprising at least a switch and a load resistor which is connected between both ends of each of the battery cells configuring the battery pack.

4. The apparatus of claim 3, wherein the temperature detector measuring a temperature near at least a load resistor.

5. The apparatus of claim 1, wherein the cell balancing executor and the temperature detector are mounted as SMD components on one PCB.

6. The apparatus of claim 2, wherein,
when the cell voltage differential is greater than a first target differential, the cell balancing controller compares the temperature of the cell balancing executor with a set temperature value, and, when the temperature of the cell balancing executor is not greater than the set temperature value as the compared result, the balancing duty is decided as a maximum value.

7. The apparatus of claim 2, wherein,
when the cell voltage differential is greater than a first target differential, the cell balancing controller compares the temperature of the cell balancing executor with a set temperature value, and, when the temperature of the cell balancing executor is greater than the set temperature value, the cell balancing controller decides a balancing duty corresponding to the temperature of the cell balancing executor in a temperature-balancing function where the balancing duty is linearly reduced from a maximum value to zero within a range of from the set temperature value to a protection operation temperature value.

8. The apparatus of claim 2, wherein,
when the balancing duty is decided as the maximum value, the cell balancing controller compares a second target differential with a cell voltage differential after a certain time elapses, and, when the cell voltage differential after the certain time is less than or equal to the second target differential as the compared result, the cell balancing controller compulsorily terminates cell balancing by the cell balancing executor.

9. The apparatus of claim 2, wherein,
when the balancing duty is decided as the maximum value, the cell balancing controller compares a second target differential with a cell voltage differential after a certain time elapses, and, when the cell voltage differential after the certain time is greater than the second target differential as the compared result, the cell balancing controller compares the set temperature value with a temperature of the cell balancing executor after a certain time elapses.

10. The apparatus of claim 7, wherein,
when the current temperature of the cell balancing executor is greater than the protection operation temperature value, the cell balancing controller decides the balancing duty as zero.

11. A method of equalizing energy of battery cells, the method comprising:
(a) detecting a voltage of each of a plurality of cells comprised in a battery pack to compare a cell voltage differential with a first target differential;
(b) when the cell voltage differential is greater than the first target differential, comparing a temperature of a cell balancing executor with a set temperature value;
(c) when the temperature of the cell balancing executor is not greater than a set temperature value as the compared result, deciding a balancing duty as a maximum value; and
(d) when the temperature of the cell balancing executor is greater than the set temperature value as the compared result, deciding the balancing duty on the basis of the cell voltage differential and the temperature of the cell balancing executor.

12. The method of claim 11, wherein the (d) comprising,
deciding the balancing duty corresponding to the temperature of the cell balancing executor in a temperature-balancing function where the balancing duty is linearly reduced from a maximum value to zero within a range of from the set temperature value to a protection operation temperature value.

13. The method of claim 11, further comprising:
when the balancing duty is decided as the maximum value in operation (c), comparing a second target differential with a cell voltage differential after a certain time elapses; and
when the cell voltage differential after the certain time is less than or equal to the second target differential as the compared result, compulsorily terminating cell balancing by the cell balancing executor.

14. The method of claim 11, further comprising:
when the balancing duty is decided as the maximum value in operation (c), comparing a second target differential with a cell voltage differential after a certain time elapses;
when the cell voltage differential after the certain time is greater than the second target differential as the compared result, comparing the set temperature value with a temperature of the cell balancing executor after a certain time elapses; and
selectively performing operation (c) or operation (d) according to the compared result of the temperatures.

15. The method of claim 12, wherein the (d) comprising,
when the current temperature of the cell balancing executor is greater than the protection operation temperature value, deciding a balancing duty as zero.
